(19) United States
(12) Patent Application Publication
(10) Pub. No.: US 2011/0194707 A1
(43) Pub. Date: Aug. 11, 2011

(54) Rear view sound

(76) Inventor: Anthony Jackson, Pembroke Twp., IL (US)

(21) Appl. No.: 12/931,443

(22) Filed: Jan. 31, 2011

Related U.S. Application Data
(60) Provisional application No. 61/337,049, filed on Jan. 29, 2010.

(51) Int. Cl. H04B 1/00

(52) U.S. Cl. 381/86

(57) ABSTRACT

The present invention provides an Mp3 player and AM and FM radio receiver built into a rear view mirror. Manufactured and sold as an aftermarket accessory, The Rear View Sound is produced with embodiments ideal for use in automobiles, while other embodiments are made available for use on motorcycles and bicycles. Similar in appearance to a standard rear view mirror, The Rear View Sound is sized appropriately for the designated application and boasts a hard plastic outer casing, stem and hub which is installed directly on the vehicle windshield. The mirror itself is fully adjustable and comprised of highly reflective glass material. The most notable aspect of this product however, is found in the previously mentioned Mp3 player and AM and FM radio receiver. For practical purposes, this Mp3 player and AM and FM radio receiver is removable and is secured to a dock incorporated into the design of the mirror casing. Simple operational controls, an LCD display screen and power switch are positioned on the top of the mirror, while a USB port and removable connection cable are located on the base or underside of the unit. The Rear View Sound Mp3 player and AM and FM radio receiver transmits digital audio tirelessly through the vehicle speakers.

### CLAIM OF PRIORITY

This patent application claims priority under 35 USC 119 (e) (1) from U.S. Provisional Patent Application Ser. No. 61/337,049 filed Jan. 29, 2010, of common inventorship herewith entitled, “Rear View Sound.”

### FIELD OF THE INVENTION

The present invention pertains to the field of automotive audio sound system devices, and more specifically to the field of digital audio sound devices.

### BACKGROUND OF THE INVENTION

The prior art has put forth several designs for automotive audio sound system devices. Among these are:

U.S. Pat. No. 6,166,698 to Robert R. Turnbull, et al. describes a rearview mirror assembly disclosed in which a microwave antenna is mounted so as to receive transmissions from one or more satellites through the front windshield of the vehicle. In addition an electrical control system is disclosed that may be used as a navigation system, an electrochromic rearview mirror control system, a head lamp control system, a tire pressure monitoring and display system, a temperature sensing and display system, a vehicle compass system, a vehicle data recorder system, and/or a vehicle odometer verification system.

U.S. Pat. No. 6,980,092 to Robert R. Turnbull describes a vehicle communication and control system provided that may be more readily installed in a vehicle and that utilizes minimal additional wiring. According to some of the disclosed embodiments, the electrical components of the “brick” of a communication and control system are integrated into a rearview mirror assembly.

U.S. Pat. No. 7,233,230 to John P. Drummond and Niall R. Lynam describes a vehicular rearview mirror system which includes an interior rearview mirror system that has an interior reflective element, a drive circuit, a tire pressure monitoring system and a microcontroller.

U.S. Pat. No. 7,317,386 to Marc Lengning and Bernhard Schambeck describes music information which is output to an operator, such as a vehicle operator, through the use of a portable electronic device. The operator's behavior may be determined on the basis of data received from one or more systems of a moving object which is being controlled or otherwise operated by the operator.

U.S. Pat. No. 6,297,781 to Robert R. Turnbull, et al. describes an inventive rearview mirror assembly in which a microwave antenna is mounted so as to receive transmission from one or more satellites through the front windshield of the vehicle.

None of these prior art references describe the present invention.

### SUMMARY OF THE INVENTION

It is an object of the present invention to provide a digital sound system built into a rearview mirror for automobiles, bicycles and similar devices.

### BRIEF DESCRIPTION OF THE DRAWINGS

FIG. 1 is an elevational angled perspective view of the device of the present invention installed on a bicycle.

FIG. 2 is a front perspective view of the device of the present invention installed in an automobile.

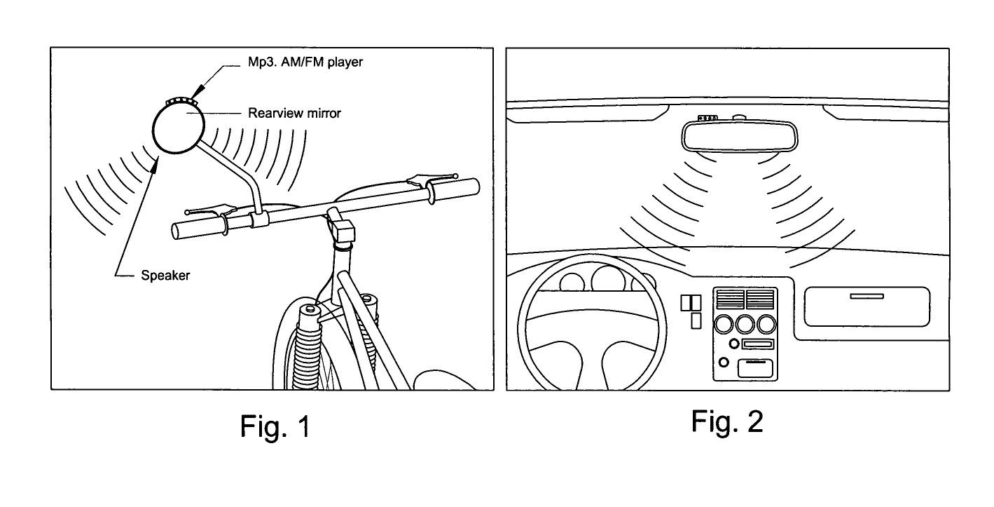

### DETAILED DESCRIPTION OF THE INVENTION

The way we listen to music has changed drastically in recent years. The days of playing scratchy forty-five rpm records on a turntable are gone forever and it seems like even the revolutionary compact disc is quickly becoming a relic of the past. Millions of consumers now play their music on a device called an Mp3 player. An Mp3 player is a digital audio player or “DAP”, a portable electronics device that stores, organizes and plays audio files. Some DAPS are referred to as portable media players as they have image viewing or video playing support software. Most DAP's are powered by rechargeable batteries. Music played through a DAP or Mp3 player is crystal clear and can be enjoyed at even top volume without compromising sound integrity.

The present invention, hereinafter referred as The Rear View Sound is a specially designed portable Mp3 player built into a rear view mirror. The device also incorporates a radio receiver for receiving AM and FM signals. Manufactured and sold as an aftermarket accessory, The Rear View Sound is produced with embodiments ideal for use in automobiles, while other embodiments are made available for use on motorcycles and bicycles. Similar in appearance to a standard rear view mirror, The Rear View Sound is sized appropriately for the designated application and boasts a hard plastic outer casing, stem and hub which is installed directly on the vehicle windshield. The mirror itself is fully adjustable and comprised of highly reflective glass material. The most notable aspect of this product however, is found in the previously mentioned Mp3 player. For practical purposes, this Mp3 player is removable and is secured to a dock incorporated into the design of the mirror casing. Simple operational controls, an LCD display screen and power switch are positioned on the top of the mirror, while a USB port and removable connection cable are located on the base or underside of the unit. The Rear View Sound Mp3 player transmits digital audio tirelessly through the vehicle speakers.

The Rear View Sound is an innovative product invention which provides a unique means of enjoying digital music. A cleverly designed Mp3 player and AM and FM radio receiver incorporated into the design of a rear view mirror, The Rear View Sound provides a new and novel approach to enjoying one's favorite music. Allowing users to enjoy their favorite digital music while on the road, The Rear View Sound is especially appreciated on long drives or daily commutes. With embodiments developed for installation in cars and trucks, motorcycles and bicycles, there are models of The Rear View Sound to accommodate any need. In particular, young adults, teens and children especially appreciate the many benefits this useful product affords. Durably constructed, this product withstands years of continual use.

The Rear View Sound is a cleverly designed product invention which combines two functional accessories into one practical unit. A portable Mp3 player and AM and Fm radio receiver built into a rear view mirror, this portable digital player appeals to a variety of consumers.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A portable Mp3 player and AM and FM radio receiver built into a rear view mirror, comprising: a hard plastic outer casing, stem and hub which is installed directly on the vehicle windshield and wherein the mirror itself is fully adjustable and comprised of highly reflective glass material.

2. The Mp3 player and AM and FM radio receiver of claim 1 wherein the Mp3 player and AM and FM radio receiver is removable and is secured to a dock incorporated into the design of the mirror casing and wherein an LCD display screen and power switch are positioned on the top of the mirror and having a USB port and removable connection cable located on the underside of the player.

3. The Mp3 and AM and FM radio receiver player of claim 1 wherein the player transmits digital audio signals through the vehicle speakers.

4. The Mp3 player and AM and FM radio receiver of claim 1 wherein the vehicle is an automobile.

5. The Mp3 player and AM and FM radio receiver of claim 1 wherein the vehicle is a bicycle or motorcycle.
